(19) United States
(12) Patent Application Publication
(10) Pub. No.: US 2017/0011676 A1
(43) Pub. Date: Jan. 12, 2017

(54) Light Emitting Diode Display Device

(71) Applicant: APIX, Inc., Hsinchu City (TW)

(72) Inventor: Chung-Yu Wu, Hsinchu (TW)

(21) Appl. No.: 15/045,415

(22) Filed: Feb. 17, 2016

(30) Foreign Application Priority Data
Jul. 7, 2015 (TW) 104122026

(51) Int. Cl. G09G 3/20; G09G 3/32

(52) U.S. Cl. CPC G09G 3/2003; G09G 3/32

(57) ABSTRACT

A light emitting diode (LED) display device includes a plurality of pixel units, a plurality of current sources and a plurality of switches. The pixel units are arranged in a matrix with a plurality of rows and a plurality of columns. Each pixel unit includes a plurality of LEDs of different colors. Each current source is coupled to cathodes of the LEDs in a respective column for providing a respective driving current signal thereto. Each switch is coupled to anodes of the LEDs that are of a corresponding color and in a corresponding row. The switches that correspond to the LEDs of the same color are used to receive a corresponding power supply voltage.

### CROSS-REFERENCE TO RELATED APPLICATION

This application claims priority of Taiwanese Application No. 104122026, filed on Jul. 7, 2015.

### FIELD

This disclosure relates to a display device, and more particularly to a light emitting diode display device.

### BACKGROUND

Referring to FIGS. 1 and 2, a conventional light emitting diode (LED) display device includes sixteen pixel units 3, four switches (S1-S4) and twelve current sources (Ir1-Ir4, Ig1-Ig4, Ib1-Ib4).

The pixel units 3 are arranged in a matrix with four rows and four columns. Each pixel unit 3 includes a red LED 8, a green LED 9 and a blue LED 10. Each LED 8-10 has an anode and a cathode.

The switch (Si) has a first terminal that receives a power supply voltage (V), and a second terminal that is coupled to the anodes of the LEDs 8-10 in an i^{th} one of the rows, where 1≦i≦4.

The current sources (Ir1-Ir4, Ig1-Ig4, Ib1-Ib4) respectively generate twelve driving current signals (ir1-ir4, ig1-ig4, ib1-ib4). The current source (Irj) is coupled to the cathodes of the red LEDs 8 in a j^{th} one of the columns for supplying the driving current signal (irj) thereto, the current source (Igj) is coupled to the cathodes of the green LEDs 9 in the j^{th} column for supplying the driving current signal (igj) thereto, and the current source (Ibj) is coupled to the cathodes of the blue LEDs 10 in the j^{th} columns for supplying the driving current signal (ibj) thereto, where 1≦j≦4.

Each LED 8-10 emits light during a time period in which a corresponding switch (S1-S4) operates in an ON state and the driving current signal (ir1-ir4, ig1-ig4 ib1-ib4) generated by a corresponding current source (Ir1-Ir4, Ig1-Ig4, Ib1-Ib4) is non-zero, and does not emit light otherwise.

The conventional LED display device is operable among first to fourth modes.

In the first mode, the first switch (S1) can operate in the ON state, the other switches (S2-S4) operate in an OFF state, and the driving current signals (ir1-ir4, ig1-ig4, ib1-ib4) generated by the current sources (Ir1-Ir4, Ig1-Ig4, Ib1-Ib4) can be non-zero. Therefore, the LEDs 8-10 in the first row can emit light, and the LEDs 8-10 in the other rows do not emit light.

In the second mode, the second switch (S2) can operate in the ON state, the other switches (S1, S3, S4) operate in the OFF state, and the driving current signals (ir1-ir4, ig1-ig4, ib1-ib4) generated by the current sources (Ir1-Ir4, Ig1-Ig4, Ib1-Ib4) can be non-zero. Therefore, the LEDs 8-10 in the second row can emit light, and the LEDs 8-10 in the other rows do not emit light.

In the third mode, the third switch (S3) can operate in the ON state, the other switches (S1, S2, S4) operate in the OFF state, and the driving current signals (ir1-ir4, ig1-ig4, ib1-ib4) generated by the current sources (Ir1-Ir4, Ig1-Ig4, Ib1-Ib4) can be non-zero. Therefore, the LEDs 8-10 in the third row can emit light, and the LEDs 8-10 in the other rows do not emit light.

In the fourth mode, the fourth switch (S4) can operate in the ON state, the other switches (S1-S3) operate in the OFF state, and the driving current signals (ir1-ir4, ig1-ig4, ib1-ib4) generated by the current sources (Ir1-Ir4, Ig1-Ig4, Ib1-Ib4) can be non-zero. Therefore, the LEDs 8-10 in the fourth row can emit light, and the LEDs 8-10 in the other rows do not emit light.

The conventional LED display device has the following disadvantages:

1. Each red LED 8 has a forward voltage of about 2.1V-2.6V. Each green LED 9 has a forward voltage of about 3.3V-3.9V. Each blue LED 10 has a forward voltage of about 3.2V-4.1V. Therefore, for proper operations of the current sources (Ir1-Ir4, Ig1-Ig4, Ib1-Ib4), the power supply voltage (V) must be greater than 4.1V, which results in a waste of power on, e.g., the current sources (Ir1-Ir4).

2. For each pixel unit 3, since the LEDs 8-10 may emit light simultaneously, an instantaneous temperature of the pixel unit 3 may be relatively high, which results in a relatively short lifetime of the pixel unit 3 and a relatively low electrical-to-optical conversion efficiency of each LED 8-10.

### SUMMARY

Therefore, an object of this disclosure is to provide a light emitting diode (LED) display device that can alleviate at least one of the drawbacks of the prior art.

According to this disclosure, an LED display device includes a plurality of pixel units, a plurality of current sources and a plurality of switches. The pixel units are arranged in a matrix with a plurality of rows and a plurality of columns. Each of the pixel units includes a plurality of LEDs of different colors. Each of the LEDs has an anode and a cathode. The current sources respectively generate a plurality of driving current signals. Each of the current sources is coupled to the cathodes of the LEDs in a respective one of the columns for providing the respective one of the driving current signals thereto. Each of the switches has a first terminal and a second terminal. The second terminal of each of the switches is coupled to the anodes of the LEDs that are of a corresponding one of the colors and in a corresponding one of the rows. For the LEDs of each of the colors, the first terminals of the switches that correspond thereto are used to receive a corresponding one of different power supply voltages.

### BRIEF DESCRIPTION OF THE DRAWINGS

Other features and advantages of this disclosure will become apparent in the following detailed description of the embodiment (s) with reference to the accompanying drawings, of which:

FIG. 1 is a schematic circuit diagram illustrating a conventional light emitting diode (LED) display device;

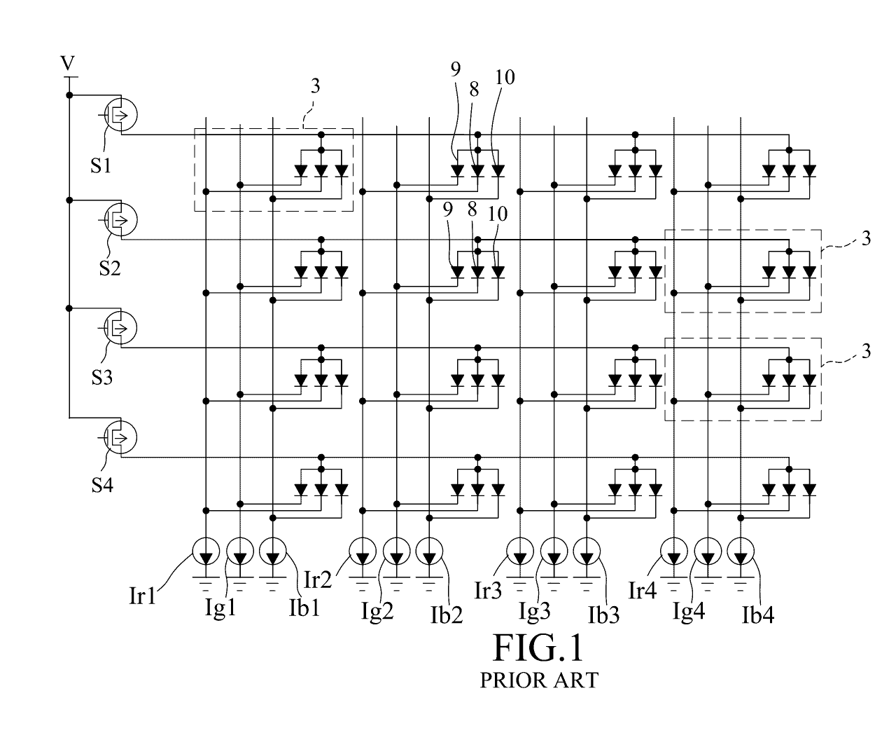

FIG. 2 is a timing diagram illustrating operation of the conventional LED display device;

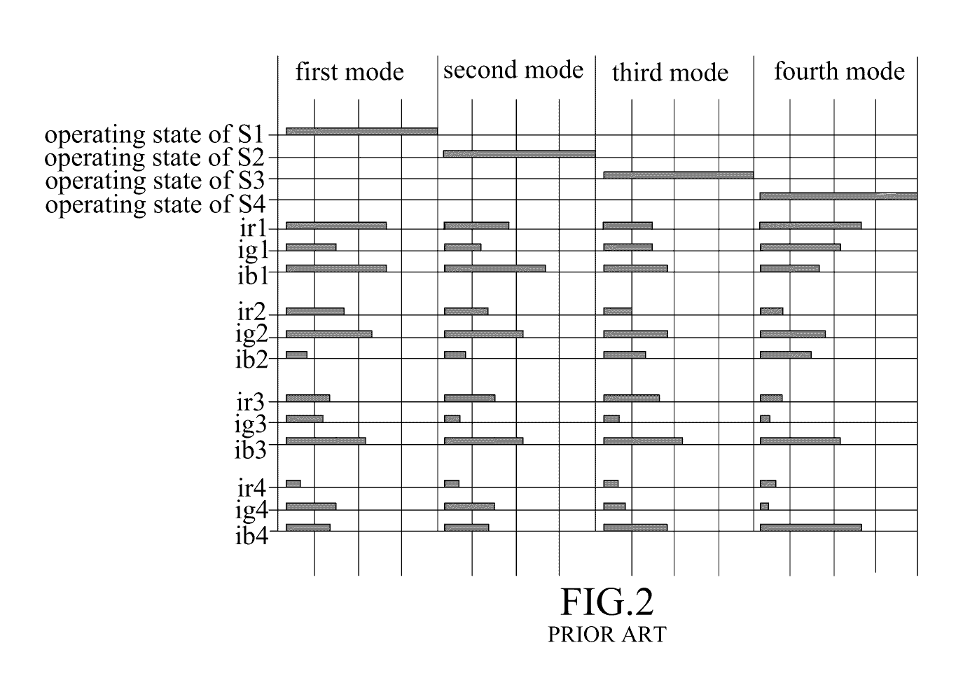

FIG. 3 is a schematic circuit diagram illustrating an exemplary implementation of a first embodiment of an LED display device according to this disclosure;

FIG. 4 is a timing diagram illustrating operation of the exemplary implementation of the first embodiment;

FIG. 5 is a schematic circuit diagram illustrating an exemplary implementation of a second embodiment of an LED display device according to this disclosure; and

FIG. 6 is a timing diagram illustrating operation of the exemplary implementation of the second embodiment.

### DETAILED DESCRIPTION

A first embodiment of a light emitting diode (LED) display device according to this disclosure includes a number (Y×N) of pixel units, a number (Y) of first current sources, a number (M×N) of switches and a controller, where Y>1, N>1 and M>1.

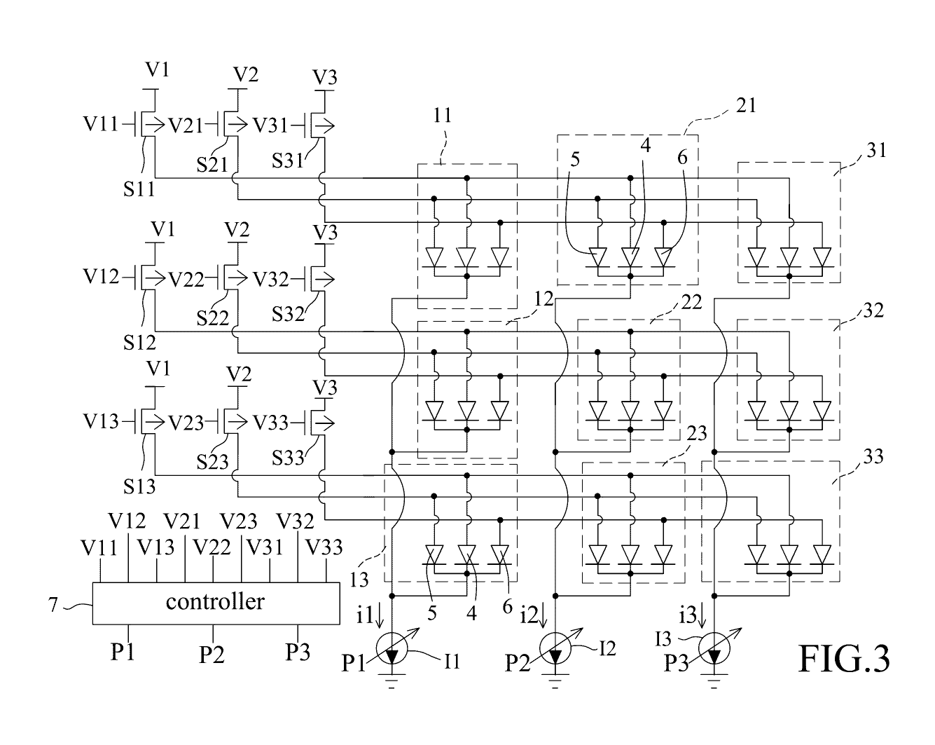

In an example depicted in FIG. 3, Y=3, N=3, M=3. As such, there are nine pixel units 11-13, 21-23, 31-33, three first current sources (I1-I3), and nine switches (S11-S13, S21-S23, S31-S33). The controller is labeled 7.

The pixel units are arranged in a matrix with a number (N) of rows and a number (Y) of columns. For example, in the example depicted in FIG. 3, the pixel unit (yn) is in a y^{th} one of the columns and an n^{th} one of the rows, where 1≦y≦Y and 1≦n≦N with Y=3 and N=3. Each pixel unit includes a number (M) of first LEDs of different colors. For example, in the example depicted in FIG. 3, each pixel unit 11-13, 21-23, 31-33 includes a red first LED 4, a green first LED 5 and a blue first LED 6. Each first LED has an anode and a cathode.

The first current sources respectively receive a number (Y) of first current control signals, and respectively generate a number (Y) of first driving current signals based respectively on the first current control signals. Each first current source is coupled to the cathodes of the first LEDs in a respective column for providing the respective first driving current signal thereto. For example, in the example depicted in FIG. 3, the first current source (Iy) receives the first current control signal (Py), generates the first driving current signal (iy), and is coupled to the cathodes of the first LEDs 4-6 in the y^{th} column for providing the first driving current signal (iy) thereto, where 1≦y≦Y with Y=3. In this embodiment, each first driving current signal pulsates between zero and a predetermined non-zero value, and has a variable total pulse width varying mode by mode according to the respective first current control signal.

Each switch has a first terminal, a second terminal and a control terminal The second terminal of each switch is coupled to the anodes of the first LEDs that are of a corresponding color and in a corresponding row. For example, in the example depicted in FIG. 3, the second terminal of the switch (S1n) is coupled to the anodes of the red first LEDs 4 in the n^{th} row, the second terminal of the switch (S2n) is coupled to the anodes of the green first LEDs 5 in the n^{th} and the second terminal of the switch (S3n) is coupled to the anodes of the blue first LEDs 6 in the n^{th} row, where 1≦n≦N with N=3. The first terminals of the switches that correspond to the first LEDs of the same color are used to receive a corresponding one of a number (M) of different power supply voltages. For example, in the example depicted in FIG. 3, the first terminals of the switches (S11-S13) that correspond to the red first LEDs 4 are used to receive the power supply voltage (V1), the first terminals of the switches (S21-S23) that correspond to the green first LEDs 5 are used to receive the power supply voltage (V2), and the first terminal s of the switches (S31-S33) that correspond to the blue first LEDs 6 are used to receive the power supply voltage (V3). The control terminals of the switches respectively receive a number (M×N) of switching control signals. Each switch is operable between an ON state and an OFF state based on a respective switching control signal. In the example depicted in FIG. 3, the control terminals of the switches (S11-S13, S21-S23, S31-S33) respectively receive nine switching control signals (V11-V13, V21-V23, V31-V33), and each switch (S11-S13, S21-S23, S31-S33) is a P-type metal oxide semiconductor field effect transistor (PMOSFET) that has a source terminal serving as the first terminal, a drain terminal serving as the second terminal, and a gate terminal serving as the control terminal, but this disclosure is not limited thereto.

The controller 7 (see FIG. 3) is coupled to the first current sources and the control terminals of the switches, and generates the first current control signals respectively for the first current sources and the switching control signals respectively for the control terminals of the switches.

Each first LED emits light during a time period in which a corresponding switch operates in the ON state and the first driving current signal generated by a corresponding first current source is non-zero, and does not emit light otherwise.

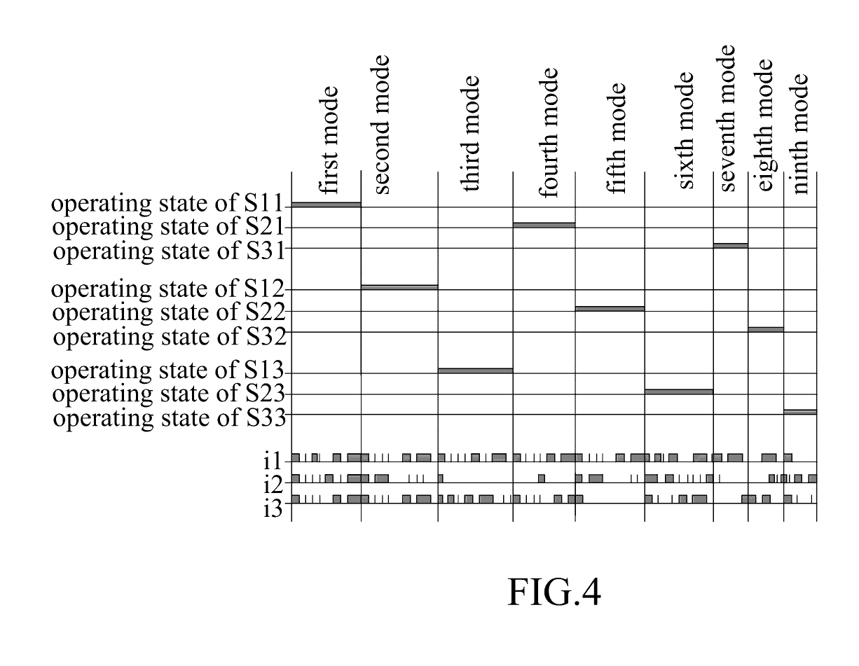

Referring to FIG. 4, in the example depicted in FIG. 3, the first current control signals (P1-P3) and the switching control signals (V11-V13, V21-V23, V31-V33) are configured in such a way that the LED display device is operable among first to ninth modes.

In the first mode, the switch (S11) operates in the ON state, the other switches (S12, S13, S21-S23, S31-S33) operate in the OFF state, and the first driving current signals (i1-i3) generated by the first current sources (I1-I3) can be non-zero. Therefore, the red first LEDs 4 in the first row can emit light, and the green and blue first LEDs 5, 6 in the first row and the red, green and blue first LEDs 4-6 in the second and third rows do not emit light.

In the second mode, the switch (S12) operates in the ON state, the other switches (S11, S13, S21-S23, S31-S33) operate in the OFF state, and the first driving current signals (i1-i3) generated by the first current sources (I1-I3) can be non-zero. Therefore, the red first LEDs 4 in the second row can emit light, and the green and blue first LEDs 5, 6 in the second row and the red, green and blue first LEDs 4-6 in the first and third rows do not emit light.

In the third mode, the switch (S13) operates in the ON state, the other switches (S11, S12, S21-S23, S31-S33) operate in the OFF state, and the first driving current signals (i1-i3) generated by the first current sources (I1-I3) can be non-zero. Therefore, the red first LEDs 4 in the third row can emit light, and the green and blue first LEDs 5, 6 in the third row and the red, green and blue first LEDs 4-6 in the first and second rows do not emit light.

In the fourth mode, the switch (S21) operates in the ON state, the other switches (S11-S13, S22, S23, S31-S33) operate in the OFF state, and the first driving current signals (i1-i3) generated by the first current sources (I1-I3) can be non-zero. Therefore, the green first LEDs 5 in the first row can emit light, and the red and blue first LEDs 4, 6 in the first row and the red, green and blue first LEDs 4-6 in the second and third rows do not emit light.

In the fifth mode, the switch (S22) operates in the ON state, the other switches (S11-S13, S21, S23, S31-S33) operate in the OFF state, and the first driving current signals (i1-i3) generated by the first current sources (I1-I3) can be non-zero. Therefore, the green first LEDs 5 in the second row can emit light, and the red and blue first LEDs 4, 6 in the second row and the red, green and blue first LEDs 4-6 in the first and third rows do not emit light.

In the sixth mode, the switch (S23) operates in the ON state, the other switches (S11-S13, S21, S22, S31-S33) operate in the OFF state, and the first driving current signals (i1-i3) generated by the first current sources (I1-I3) can be non-zero. Therefore, the green first LEDs 5 in the third row can emit light, and the red and blue first LEDs 4, 6 in the third row and the red, green and blue first LEDs 4-6 in the first and second rows do not emit light.

In the seventh mode, the switch (S31) operates in the ON state, the other switches (S11-S13, S21-S23, S32, S33) operate in the OFF state, and the first driving current signals (i1-i3) generated by the first current sources (I1-I3) can be non-zero. Therefore, the blue first LEDs 6 in the first row can emit light, and the red and green first LEDs 4, 5 in the first row and the red, green and blue first LEDs 4-6 in the second and third rows do not emit light.

In the eighth mode, the switch (S32) operates in the ON state, the other switches (S11-S13, S21-S23, S31, S33) operate in the OFF state, and the first driving current signals (i1-i3) generated by the first current sources (I1-I3) can be non-zero. Therefore, the blue first LEDs 6 in the second row can emit light, and the red and green first LEDs 4, 5 in the second row and the red, green and blue first LEDs 4-6 in the first and third rows do not emit light.

In the ninth mode, the switch (S33) operates in the ON state, the other switches (S11-S13, S21-S23, S31, S32) operate in the OFF state, and the first driving current signals (i1-i3) generated by the first current sources (I1-I3) can be non-zero. Therefore, the blue first LEDs 6 in the third row can emit light, and the red and green first LEDs 4, 5 in the third row and the red, green and blue first LEDs 4-6 in the first and second rows do not emit light.

It is noted that in other embodiments, the following modifications may be made:

1. Each first driving current signal may be variable according to the respective first current control signal.

2. The first current control signals and the switching control signals may be configured in such a way that the first LEDs of the pixel units emit light one at a time in a predetermined sequence.

In view of the above, the LED display device of this embodiment has the following advantages:

1. The power supply voltages can by properly chosen (e.g., in the example depicted in FIG. 3, it may be that V1<V2, V1<V3 and V2≅V3) so as to reduce a waste of power on the first current sources while ensuring proper operations of the first current sources.

2. For each pixel unit, the first LEDs emit light one at a time, and thus an instantaneous temperature of the pixel unit may be relatively low, which results in a relatively long lifetime of the pixel unit and a relatively high electrical-to-optical conversion efficiency of each first LED.

A second embodiment of an LED display device according to this disclosure is a modification of the first embodiment, and differs from the first embodiment in that:

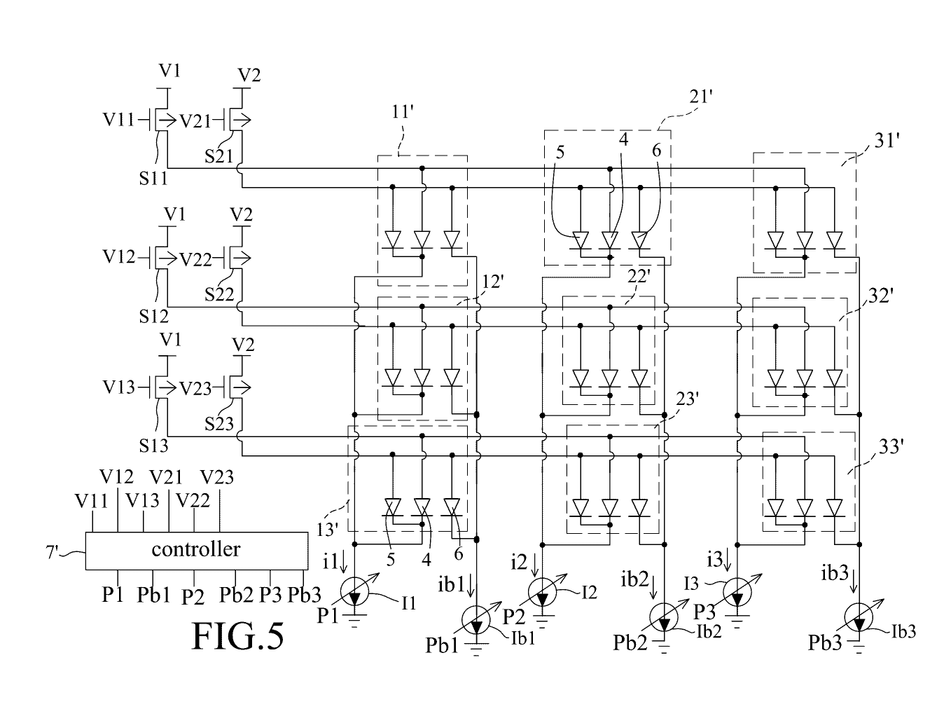

1. The LED display device further includes a number (Y) of second current sources. In an example depicted in FIG. 5, Y=3, N=3, M=2. As such, there are nine pixel units 11′-13′, 21′-23′, 31′-33′, three first current sources (I1-I3), three second current sources (Ib1-Ib3), and six switches (S11-S13, S21-S23).

2. Each pixel unit further includes a second LED which is of a color different from that of each first LED, and which has an anode and a cathode. For example, in the example depicted in FIG. 5, each pixel unit 11′-13′, 21′-23′, 31′-33′ includes a red first LED 4, a green first LED 5 and a blue second LED 6.

3. The second current sources respectively receive a number (Y) of second current control signals, and respectively generate a number (Y) of second driving current signals based respectively on the second current control signals. Each second current source is coupled to the cathodes of the second LEDs in a respective column for providing the respective second driving current signal thereto. For instance, in the example depicted in FIG. 5, the second current source (Iby) receives the second current control signal (Pby), generates the second driving current signal (iby), and is coupled to the cathodes of the second LEDs 6 in the y^{th} column for providing the second driving current signal (iby) thereto, where 1≦y≦Y with Y=3. In this embodiment, each second driving current signal pulsates between zero and a predetermined non-zero value, and has a variable total pulse width varying mode by mode according to the respective second current control signal.

4. For the first LEDs of one of the colors, the second terminal of each of the switches that correspond thereto is coupled further to the anodes of the second LEDs in the corresponding row. For example, in the example depicted in FIG. 5, the second terminal of the switch (S2n) is coupled to the anodes of the green first LEDs 5 in the n^{th} row, and further to the anodes of the blue second LEDs 6 in the n^{th} row, where 1≦n≦N with N=3.

5. The controller 7′ (see FIG. 5) is coupled further to the second current sources, and further generates the second current control signals respectively for the second current sources.

Each second LED emits light during a time period in which a corresponding switch operates in the ON state and the second driving current signal generated by a corresponding second current source is non-zero, and does not emit light otherwise.

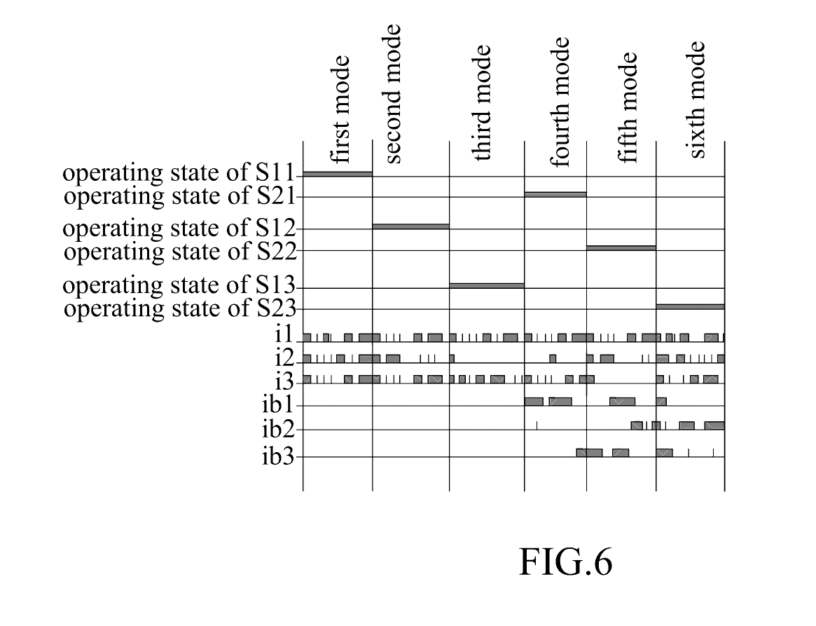

Referring to FIG. 6, in the example depicted in FIG. 5, the first and second current control signals (P1-P3, Pb1-Pb3) and the switching control signals (V11-V13, V21-V23) are configured in such a way that the LED display device is operable among first to sixth modes.

In the first mode, the switch (S11) operates in the ON state, the other switches (S12, S13, S21-S23) operate in the OFF state, the first driving current signals (i1-i3) generated by the first current sources (I1-I3) can be non-zero, and the second driving current signals (ib1-ib3) generated by the second current sources (Ib1-Ib3) are zero. Therefore, the red first LEDs 4 in the first row can emit light, and the green first LEDs 5 in the first row, the blue second LEDs 6 in the first row and the LEDs 4-6 in the second and third rows do not emit light.

In the second mode, the switch (S12) operates in the ON state, the other switches (S11, S13, S21-S23) operate in the OFF state, the first driving current signals (i1-i3) generated by the first current sources (I1-I3) can be non-zero, and the second driving current signals (ib1-ib3) generated by the second current sources (Ib1-Ib3) are zero. Therefore, the red first LEDs 4 in the second row can emit light, and the green first LEDs 5 in the second row, the blue second LEDs 6 in the second row and the LEDs 4-6 in the first and third rows do not emit light.

In the third mode, the switch (S13) operates in the ON state, the other switches (S11, S12, S21-S23) operate in the OFF state, the first driving current signals (i1-i3) generated by the first current sources (I1-I3) can be non-zero, and the second driving current signals (ib1-ib3) generated by the second current sources (Ib1-Ib3) are zero. Therefore, the red first LEDs 4 in the third row can emit light, and the green first LEDs 5 in the third row, the blue second LEDs 6 in the third row and the LEDs 4-6 in the first and second rows do not emit light.

In the fourth mode, the switch (S21) operates in the ON state, the other switches (S11-S13, S22, S23) operate in the OFF state, and the first driving current signals (i1-i3) generated by the first current sources (I1-I3) and the second driving current signals (ib1-ib3) generated by the second current sources (Ib1-Ib3) can be non-zero. Therefore, the green first LEDs 5 in the first row and the blue second LEDs 6 in the first row can emit light, and the red first LEDs 4 in the first row and the LEDs 4-6 in the second and third rows do not emit light.

In the fifth mode, the switch (S22) operates in the ON state, the other switches (S11-S13, S21, S23) operate in the OFF state, and the first driving current signals (i1-i3) generated by the first current sources (I1-I3) and the second driving current signals (ib1-ib3) generated by the second current sources (Ib1-Ib3) can be non-zero. Therefore, the green first LEDs 5 in the second row and the blue second LEDs 6 in the second row can emit light, and the red first LEDs 4 in the second row and the LEDs 4-6 in the first and third rows do not emit light.

In the sixth mode, the switch (S23) operates in the ON state, the other switches (S11-S13, S21, S22) operate in the OFF state, and the first driving current signals (i1-i3) generated by the first current sources (I1-I3) and the second driving current signals (ib1-ib3) generated by the second current sources (Ib1-Ib3) can be non-zero. Therefore, the green first LEDs 5 in the third row and the blue second LEDs 6 in the third row can emit light, and the red first LEDs 4 in the third row and the LEDs 4-6 in the first and second rows do not emit light.

It is noted that in other embodiments, the following modifications may be made:

1. Each first driving current signal may be variable according to the respective first current control signal, and each second driving current signal may be variable according to the respective second current control signal.

2. The first and second current control signals and the switching control signals may be configured in such a way that the first and second LEDs of each pixel unit emit light one at a time in a predetermined sequence.

3. The first and second current control signals and the switching control signals may be configured in such a way that the first and second LEDs of the pixel units emit light one at a time in a predetermined sequence.

In view of the above, the LED display device of this embodiment has the following advantages:

1. The power supply voltages can by properly chosen (e.g., in the example depicted in FIG. 5, it may be that V1<V2) so as to reduce a waste of power on the first current sources while ensuring proper operations of the first current sources.

2. For each pixel unit, the LEDs emit light at most two at a time, and thus an instantaneous temperature of the pixel unit may be relatively low, which results in a relatively long lifetime of the pixel unit and a relatively high electrical-to-optical conversion efficiency of each LED.

While this disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A light emitting diode (LED) display device comprising:
a plurality of pixel units which are arranged in a matrix with a plurality of rows and a plurality of columns, and each of which includes a plurality of first LEDs of different colors, each of said first LEDs having an anode and a cathode;
a plurality of first current sources which respectively generate a plurality of first driving current signals, and each of which is coupled to said cathodes of said first LEDs in a respective one of said columns for providing the respective one of the first driving current signals thereto; and
a plurality of switches, each of which has a first terminal and a second terminal, said second terminal of each of said switches being coupled to said anodes of said first LEDs that are of a corresponding one of the colors and in a corresponding one of said rows,
wherein for said first LEDs of each of the colors, said first terminals of said switches that correspond thereto are used to receive a corresponding one of different power supply voltages.

2. The LED display device of claim 1, wherein said first current sources respectively receive a plurality of first current control signals, and respectively generate the first driving current signals based respectively on the first current control signals.

3. The LED display device of claim 2, wherein each of said switches further includes a control terminal, said control terminals of said switches respectively receive a plurality of switching control signals, and each of said switches is operable between an ON state and an OFF state based on the respective one of the switching control signals.

4. The LED display device of claim 3, further comprising a controller which is coupled to said first current sources and said control terminals of said switches, and which generates the first current control signals respectively for said first current sources and the switching control signals respectively for said control terminals of said switches.

5. The LED display device of claim 4, wherein the first current control signals and the switching control signals are configured in such a way that said first LEDs of each of said pixel units emit light one at a time.

6. The LED display device of claim 1, wherein each of said pixel units further includes a second LED which is of a color different from that of each of the first LEDs, and which has an anode and a cathode; and
wherein for said first LEDs of one of the colors, said second terminal of each of said switches that correspond thereto is coupled further to said anodes of said second LEDs in the corresponding one of said rows;
said LED display device further comprising a plurality of second current sources which respectively generate a plurality of second driving current signals, and each of which is coupled to said cathodes of said second LEDs in a respective one of said columns for providing the respective one of the second driving current signals thereto.

7. The LED display device of claim 6, wherein:
said first current sources respectively receive a plurality of first current control signals, and respectively generate the first driving current signals based respectively on the first current control signals; and
said second current sources respectively receive a plurality of second current control signals, and respectively generate the second driving current signals based respectively on the second current control signals.

8. The LED display device of claim 7, wherein each of said switches further includes a control terminal, said control terminals of said switches respectively receive a plurality of switching control signals, and each of said switches is operable between an ON state and an OFF state based on the respective one of the switching control signals.

9. The LED display device of claim 8, further comprising a controller which is coupled to said first and second current sources and said control terminals of said switches, and which generates the first and second current control signals respectively for said first and second current sources and the switching control signals respectively for said control terminals of said switches.
